(19) United States
(12) Patent Application Publication
(10) Pub. No.: US 2020/0220343 A1
(43) Pub. Date: Jul. 9, 2020

(54) SLIDING GROMMET FOR A WIRING HARNESS IN A WASHING MACHINE APPLIANCE

(71) Applicant: Haier US Appliance Solutions, Inc., Wilmington, DE (US)

(72) Inventor: James K. Willis, JR., Louisville, KY (US)

(21) Appl. No.: 16/238,594

(22) Filed: Jan. 3, 2019

(51) Int. Cl. H02G 3/22; D06F 33/02; H01B 7/00

(52) U.S. Cl. CPC H02G 3/22; H01B 7/0045; D06F 33/02

(57) ABSTRACT

A washing machine appliance includes a tub suspended within a cabinet such that the tub is movable relative to the cabinet. A basket is rotatably mounted within the tub. A control board is positioned within the cabinet such that the control board is spaced from the tub. An electric component is mounted to the tub. A grommet is mounted to the cabinet. A wiring harness electrically connects the control board and the electric component. A first portion of the wiring harness is fixed to the tub. A second portion of the wiring harness is received within the grommet such that the wiring harness is slidable within the grommet.

### FIELD OF THE INVENTION

The present subject matter relates generally to wiring harnesses for washing machine appliances.

### BACKGROUND OF THE INVENTION

In certain washing machine appliances, a tub and a basket are positioned within a cabinet. Articles for washing can be loaded into the basket, and the basket can rotate within the tub during operation of the washing machine appliance to assist with washing the articles within the basket. The tub is suspended within the cabinet to reduce transmission of motion from the tub to the cabinet while the basket is spinning within the tub.

Various electrical components are mounted to the tub, such as a motor for rotating the basket, and a wiring harness extends from a control board on the cabinet to the tub for powering the electrical components on the tub. Known mechanisms for securing wiring harness between the cabinet and the tub suffer drawbacks. For example, one end of the wiring harness may be fixed to the cabinet, and the other end of the wiring harness may be fixed to the tub. Sufficient slack in the wiring harness between the fixed ends of the wiring harness may account for movement of the tub relative to the cabinet while the basket is spinning within the tub. Over time, securing the wiring harness in such a manner can lead to mechanical flex fatigue induced breakage, particularly at the locations where the wiring harness is fixed to the tub and cabinet.

### BRIEF DESCRIPTION OF THE INVENTION

Aspects and advantages of the invention will be set forth in part in the following description, or may be apparent from the description, or may be learned through practice of the invention.

In a first example embodiment, a washing machine appliance includes a cabinet. A tub is suspended within the cabinet such that the tub is movable relative to the cabinet. A basket is rotatably mounted within the tub. A control board is positioned within the cabinet such that the control board is spaced from the tub. An electric component is mounted to the tub. A grommet is mounted to the cabinet. A wiring harness electrically connects the control board and the electric component. A first portion of the wiring harness is fixed to the tub. A second portion of the wiring harness is received within the grommet such that the wiring harness is slidable within the grommet.

In a second example embodiment, a vertical axis washing machine appliance includes a cabinet. A tub is suspended within the cabinet such that the tub is movable relative to the cabinet. A basket is mounted within the tub such that the basket is rotatable about a vertical axis within the tub. A control board is positioned over the tub within the cabinet. An electric component is mounted to the tub. A grommet is mounted to the cabinet and positioned over the tub. A wiring harness electrically connects the control board and the electric component. A first portion of the wiring harness is fixed to the tub at a top portion of the tub. A second portion of the wiring harness is received within the grommet such that the wiring harness is slidable within the grommet.

In a third example embodiment, a washing machine appliance includes a cabinet. A tub is suspended within the cabinet such that the tub is movable relative to the cabinet. A basket is rotatably mounted within the tub. A control board is positioned within the cabinet such that the control board is spaced from the tub. An electric component is mounted to the tub. The washing machine appliance also includes a grommet. A wiring harness electrically connects the control board and the electric component. The grommet is mounted to one of the cabinet and the tub. A first portion of the wiring harness is fixed to the other of the cabinet and the tub. A second portion of the wiring harness received within the grommet such that the wiring harness is slidable within the grommet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a washing machine appliance according an example embodiment of the present subject matter.

FIG. 2 is a section view of the example washing machine appliance of FIG. 1.

FIG. 3 is schematic view of certain components of the example washing machine appliance of FIG. 1.

FIGS. 4 and 5 are partial, section views of a grommet and a wiring harness of FIG. 3 with the wiring harness shown in different positions within the grommet.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

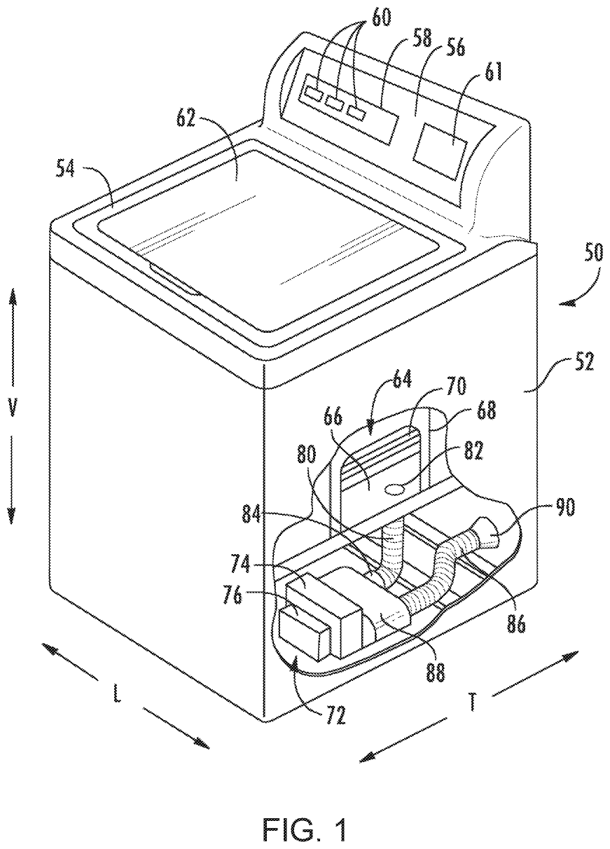

FIG. 1 provides a perspective view partially broken away of a washing machine appliance 50 according to an exemplary embodiment of the present subject matter. As may be seen in FIG. 1, washing machine appliance 50 defines a vertical direction V, a lateral direction L and a transverse direction T. The vertical direction V, lateral direction L and transverse direction T are mutually perpendicular and form an orthogonal direction system.

Washing machine appliance 50 includes a cabinet or apron 52 and a top panel or cover 54. A backsplash 56 extends from cover 54, and a control panel 58 including a plurality of input selectors 60 is coupled to backsplash 56. Control panel 58 and input selectors 60 collectively form a user interface input for operator selection of machine cycles and features, and in one embodiment a display 61 indicates selected features, a countdown timer, and other items of interest to machine users. A lid 62 is mounted to cover 54 and is rotatable about a hinge (not shown) between an open position (not shown) facilitating access to a wash tub 64 located within apron 52, and a closed position (shown in FIG. 1) forming a sealed enclosure over wash tub 64.

As illustrated in FIG. 1, washing machine appliance 50 is a vertical axis washing machine appliance. While the present disclosure is discussed with reference to a vertical axis washing machine appliance, those of ordinary skill in the art, using the disclosures provided herein, should understand that the subject matter of the present disclosure is equally applicable to other washing machine appliances, such as horizontal axis washing machine appliances.

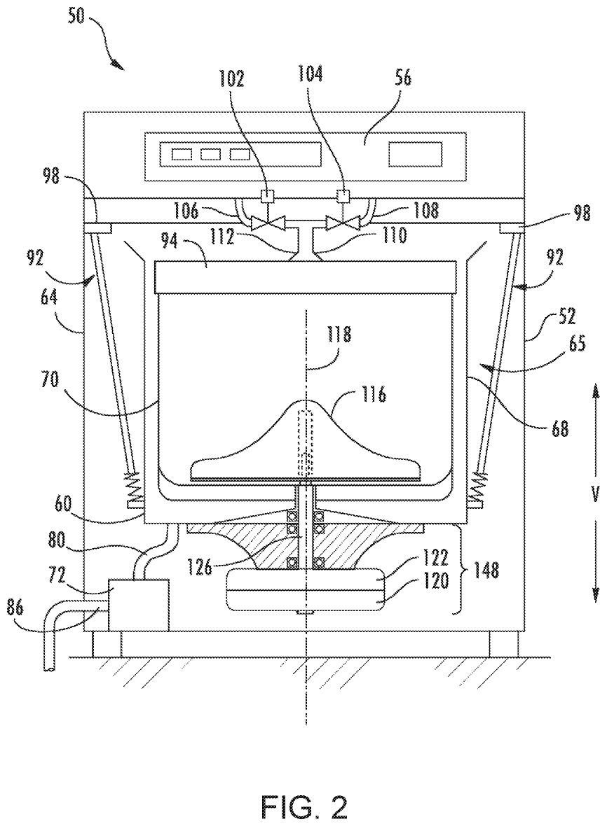

A sub-washer unit 65 (FIG. 2) is mounted within apron 52. Sub-washer unit 65 includes tub 64 and a basket 70. Tub 64 includes a bottom wall 66 and a cylindrical side wall 68, and basket 70 is rotatably mounted within wash tub 64. Bottom wall 66 of tub 64 is spaced, e.g., vertically, from an open end of cylindrical side wall 68. A pump assembly 72 is located beneath tub 64 and basket 70 for gravity assisted flow when draining tub 64. Pump assembly 72 includes a pump 74 and a motor 76. A pump inlet hose 80 extends from a wash tub outlet 82 in tub bottom wall 66 to a pump inlet 84, and a pump outlet hose 86 extends from a pump outlet 88 to an appliance washing machine water outlet 90 and ultimately to a building plumbing system discharge line (not shown) in flow communication with outlet 90.

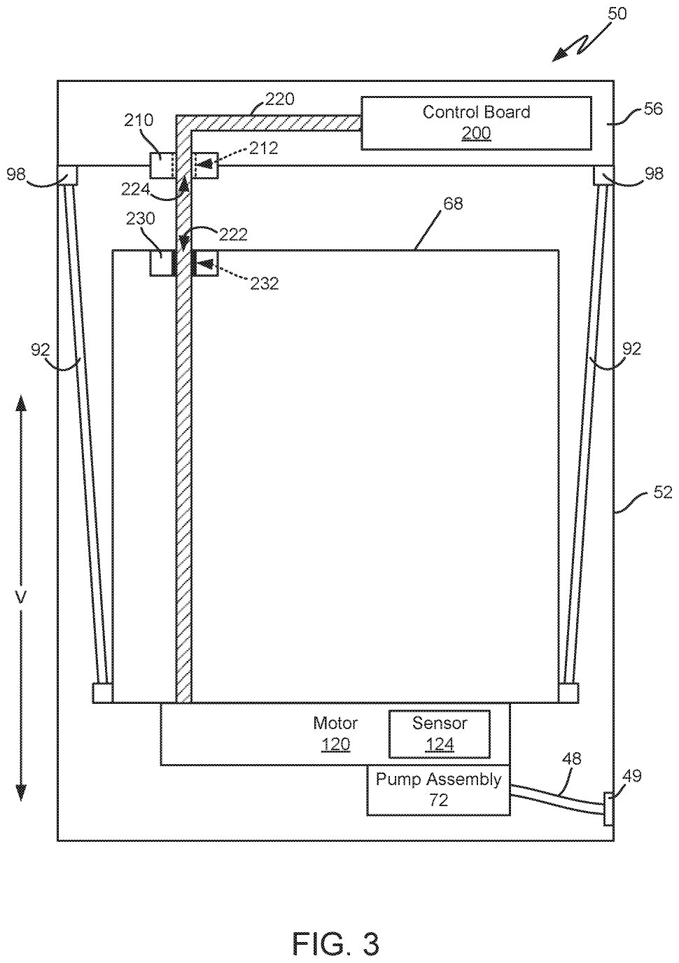

As shown in FIG. 3, pump assembly 72 may be mounted to tub 64 in alternative example embodiments. In particular, pump assembly 72 may be mounted directly to the bottom side of subwasher unit 65. Wash fluid may drain under gravity from tub 64 is pumped out of appliance 100 via pump assembly 72. The displaced wash fluid passes through a flexible bellows type hose 48, which has a discharge end attached to a rear panel mounted bracket 49, during operation of pump assembly 72.

FIG. 2 provides a front elevation schematic view of certain components washing machine appliance 50 including wash basket 70 movably disposed and rotatably mounted in wash tub 64 in a spaced apart relationship from tub side wall 68 and tub bottom 66. Basket 70 includes a plurality of perforations therein to facilitate fluid communication between an interior of basket 70 and wash tub 64.

A hot liquid valve 102 and a cold liquid valve 104 deliver fluid, such as water, to basket 70 and wash tub 64 through a respective hot liquid hose 106 and a cold liquid hose 108. Liquid valves 102, 104 and liquid hoses 106, 108 together form a liquid supply connection for washing machine appliance 50 and, when connected to a building plumbing system (not shown), provide a fresh water supply for use in washing machine appliance 50. Liquid valves 102, 104 and liquid hoses 106, 108 are connected to a basket inlet tube 110, and fluid is dispersed from inlet tube 110 through a nozzle assembly 112 having a number of openings therein to direct washing liquid into basket 70 at a given trajectory and velocity. A dispenser (not shown in FIG. 2), may also be provided to produce a wash solution by mixing fresh water with a known detergent or other composition for cleansing of articles in basket 70.

An agitation element 116, such as a vane agitator, impeller, auger, or oscillatory basket mechanism, or some combination thereof is disposed in basket 70 to impart an oscillatory motion to articles and liquid in basket 70. In various exemplary embodiments, agitation element 116 may be a single action element (oscillatory only), double action (oscillatory movement at one end, single direction rotation at the other end) or triple action (oscillatory movement plus single direction rotation at one end, single direction rotation at the other end). As illustrated in FIG. 2, agitation element 116 is oriented to rotate about a vertical axis 118.

Basket 70 and agitator 116 are driven by a motor 120 through a transmission and clutch system 122. The motor 120 drives shaft 126 to rotate basket 70 within wash tub 64. Clutch system 122 facilitates driving engagement of basket 70 and agitation element 116 for rotatable movement within wash tub 64, and clutch system 122 facilitates relative rotation of basket 70 and agitation element 116 for selected portions of wash cycles. Motor 120 and transmission and clutch system 122 collectively are referred herein as a motor assembly 148 and may be a component of sub-washer unit 65.

Sub-washer unit 65 further includes a vibration damping suspension system or mount 92 for supporting sub-washer unit 65 within apron 52. One end of mount 92 may be connected to sub-washer unit 65 while an opposite end of mount 92 is receivable within and/or coupled to at least one bracket 98. Thus, mount 92 may extend between sub-washer unit 65 and bracket 98 in order to suspend sub-washer unit 65 within apron 52.

Mount 92 can include a plurality of damping elements, such as piston-cylinder damping elements, coupled to the wash tub 64. The damping suspension system 92 can include other elements, such as a balance ring 94 disposed around the upper circumferential surface of the wash basket 70. The balance ring 94 can be used to counterbalance an out of balance condition for the wash machine as the basket 70 rotates within the wash tub 64.

Operation of washing machine appliance 50 is controlled by a controller (not shown) which is operatively coupled to the user interface input located on washing machine backsplash 56 (shown in FIG. 1) for user manipulation to select washing machine cycles and features. In response to user manipulation of the user interface input, the controller operates the various components of washing machine appliance 50 to execute selected machine cycles and features.

In an illustrative embodiment, laundry items are loaded into basket 70, and washing operation is initiated through operator manipulation of control input selectors 60 (shown in FIG. 1). Tub 64 is filled with water and mixed with detergent to form a wash fluid, and basket 70 is agitated with agitation element 116 for cleansing of laundry items in basket 70. That is, agitation element is moved back and forth in an oscillatory back and forth motion. In the illustrated embodiment, agitation element 116 is rotated clockwise a specified amount about the vertical axis of the machine, and then rotated counterclockwise by a specified amount. The clockwise and counterclockwise reciprocating motion is sometimes referred to as a stroke, and the agitation phase of the wash cycle constitutes a number of strokes in sequence. Acceleration and deceleration of agitation element 116 during the strokes imparts mechanical energy to articles in basket 70 for cleansing action. The strokes may be obtained in different embodiments with a reversing motor, a reversible clutch, or other known reciprocating mechanism. After the agitation phase of the wash cycle is completed, tub 64 is drained with pump assembly 72. Laundry items are then rinsed and portions of the cycle may be repeated, including the agitation phase, depending on the particulars of the wash cycle selected by a user.

During a spin cycle, wash basket 70 is rotated at relatively high speeds. Such high speed rotation may cause vibration and/or relative movement of the sub-washer unit 65 with respect to apron 52. As discussed in greater detail below, tub 64 includes features for damping vibrations.

FIG. 3 is schematic view of certain components of washing machine appliance 10. As may be seen in FIG. 3, washing machine appliance 50 includes a control board 200, a grommet 210 and a wiring harness 220. Control board 200 is positioned within apron 52, e.g., within backsplash 56. Control board 200 may also be spaced from tub 68 within apron 52. Wiring harness 220 electrically connects control board 200 with one or more electrical components on tub 68, such as motor 76, motor 120 or a wash fluid height sensor 124. Thus, e.g., wiring harness 220 may extend between control board 200 and the one or more electrical components on tub 68. As discussed in greater detail below, grommet 210 constrains motion of wiring harness 220, e.g., between apron 52 and tub 68 as basket 70 rotates within tub 68 such that tub 68 moves within apron 52 on the vibration damping suspension system 92.

Control board 200 may include one or more processors and a memory. The processor(s) of control board 200 can be any suitable processing device, such as a microprocessor, microcontroller, integrated circuit, or other suitable processing device. The memory of control board 200 can include any suitable computing system or media, including, but not limited to, non-transitory computer-readable media, RAM, ROM, hard drives, flash drives, or other memory devices. The memory of control board 200 can store information accessible by the processor(s) of control board 200, including instructions that can be executed by the processor(s) to control various components of washing machine appliance 50 to provide appliance functionality and data. Thus, the combination of one or more processors and memory may correspond to a controller configured to implement various programs or methods to operate washing machine appliance 50. Input/output (“I/O”) signals may be routed between control board 200 and various operational components of washing machine appliance 50, including the one or more electrical components on tub 68, along wiring harness 220 within washing machine appliance 50. Wiring harnesses 220 may include a plurality of conductive wires.

A first portion 222 of wiring harness 220 is fixed to tub 68. Thus, e.g., first portion 222 of wiring harness 220 may be fixed relative to tub 68 as basket 70 rotates within tub 68 such that tub 68 moves within apron 52 on the vibration damping suspension system 92. In contrast, first portion 222 of wiring harness 220 may move relative to apron 52 as basket 70 rotates within tub 68 such that tub 68 moves within apron 52 on the vibration damping suspension system 92. As a particular example, first portion 222 of wiring harness 220 may be fixed to tub 68 with an additional grommet 230. First, additional grommet 230 may be overmolded onto first portion 222 of wiring harness 220. Then, additional grommet 230 may be suitably fixed to tub 68, e.g., with adhesive, fasteners, clips, etc. In alternative example embodiments, first portion 222 of wiring harness 220 may be received within a through hole 232 of additional grommet 230, and an adhesive may be used to fix first portion 222 of wiring harness 220 to additional grommet 230.

Grommet 210 is mounted to apron 52. Thus, e.g., grommet 210 may be fixed relative to apron 52 as basket 70 rotates within tub 68 such that tub 68 moves within apron 52 on the vibration damping suspension system 92. In contrast, tub 68 may move relative to grommet 210 as basket 70 rotates within tub 68 such that tub 68 moves within apron 52 on the vibration damping suspension system 92.

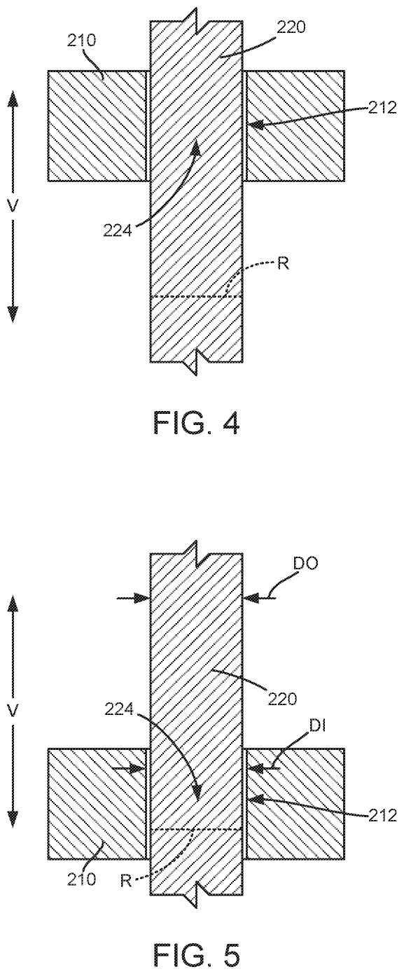

As noted above, grommet 210 constrains motion of wiring harness 220 between apron 52 and tub 68. As shown in FIGS. 3 and 4, a second portion 224 of wiring harness 220 is received within grommet 210 such that wiring harness 220 is slidable within grommet 210. Thus, wiring harness 220 may slide within grommet 210 as basket 70 rotates within tub 68 such that tub 68 moves within apron 52 on the vibration damping suspension system 92. As shown in FIG. 3, grommet 210 may be positioned over tub 68 within cabinet 52. Thus, wiring harness 220 may be slidable along the vertical direction V within grommet 210. Conversely, grommet 210 may constrain motion of wiring harness 220 within grommet 210 in a plane that is perpendicular to the vertical direction V.

In FIG. 4, a reference line R on wiring harness 220 is shown spaced from grommet 210. Conversely, the reference line R on wiring harness 220 is received within grommet 210 in FIG. 5. Thus, as shown in FIGS. 4 and 5, wiring harness 220 may slide along the vertical direction V within grommet 210. Such motion of wiring harness 220 relative to grommet 110 on apron 52 may reduce mechanical flex fatigue induced breakage of wiring harness 220 relative to known wiring harness connection methods.

To slidably mount wiring harness 220 to grommet 210, grommet 210 may define a through hole 212, and second portion 224 of wiring harness 220 may be received within through hole 212 of grommet 210. As shown in FIG. 5, an inner diameter DI of through hole 212 may be greater than an outer diameter DO of wiring harness 220 at through hole 212 of grommet 210. The smaller sizing of wiring harness 220 relative to through hole 212 of grommet 210 may allow wiring harness 220 to slide within grommet 210.

A length of wiring harness 220 between tub 68 and grommet 210 may vary when wiring harness 220 slides within grommet 210. Such length changing may advantageously reduce mechanical flex fatigue induced breakage of wiring harness 220 relative to known wiring harness connection methods. In addition, the ability to change the length of wiring harness 220 between tub 68 and grommet 210 may allow a common wiring harness to be used across multiple washing machine appliance models and designs. Any slack within wiring harness 220 may be positioned above grommet 210.

Grommet 210 may also be constructed to reduce wear on wiring harness 220 as wiring harness 220 slides within grommet 210. In particular, a sheath material of wiring harness may have a first hardness, and grommet 210 may be constructed with a material having a second hardness. The sheath material of wiring harness 220 with the first hardness contacts the material of grommet 210 with the second hardness, and the first hardness is greater than the second hardness. Thus, grommet 210 may wear preferentially to wiring harness 220.

It will be understood that the relative position of grommet 210 and additional grommet 230 may be flipped in alternative example embodiments. Thus, e.g., grommet 210 may be mounted to tub 68, and first portion 222 of wiring harness 220 may be fixed to apron 52.

As discussed above, the present subject matter provides an electrical appliance wire harness with an adjustable/sliding grommet. The grommet may allow a single wire harness design to be used across multiple washing machine models with different tub/basket sizes in contrast to known designs that require a unique harness that is optimized for each particular model. The grommet may also reduce or eliminate harness flex fatigue induced wire breakage in critical areas that often fail with conventional fixed/overmolded grommet-to-wire bundle-interface anchoring methods that overly constrain the wire harness.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, comprising:
a cabinet;
a tub suspended within the cabinet such that the tub is movable relative to the cabinet;
a basket rotatably mounted within the tub;
a control board positioned within the cabinet such that the control board is spaced from the tub;
an electric component mounted to the tub;
a grommet mounted to the cabinet; and
a wiring harness electrically connecting the control board and the electric component, a first portion of the wiring harness fixed to the tub, a second portion of the wiring harness received within the grommet such that the wiring harness is slidable within the grommet.

2. The washing machine appliance of claim 1, wherein the grommet is positioned over the tub within the cabinet, the wiring harness slidable along a vertical direction within the grommet, and the grommet constrains motion of the wiring harness within the grommet in a plane that is perpendicular to the vertical direction.

3. The washing machine appliance of claim 1, wherein a length of the wiring harness between the first and second portions of the wiring harness varies when the wiring harness slides within the grommet.

4. The washing machine appliance of claim 1, wherein the grommet defines a through hole, and the second portion of the wiring harness is received within the through hole of the grommet.

5. The washing machine appliance of claim 4, wherein a diameter of the through hole is greater than a diameter of the wiring harness received within the through hole of the grommet.

6. The washing machine appliance of claim 1, wherein the electrical component comprises a motor coupled to the basket, and the motor is operable to rotate the basket within the tub.

7. The washing machine appliance of claim 1, wherein the wiring harness has a sheath material with a first hardness, the grommet has a material with a second hardness, the sheath material with the first hardness contacts the material of the grommet with the second hardness, and the first hardness is greater than the second hardness.

8. The washing machine appliance of claim 1, wherein the wiring harness comprises a plurality of conductive wires.

9. The washing machine appliance of claim 1, wherein an additional grommet is overmolded to the wiring harness at the first portion of the wiring harness, and the additional grommet is fixed to the tub.

10. A vertical axis washing machine appliance, comprising:
a cabinet;
a tub suspended within the cabinet such that the tub is movable relative to the cabinet;
a basket mounted within the tub such that the basket is rotatable about a vertical axis within the tub;
a control board positioned over the tub within the cabinet;
an electric component mounted to the tub;
a grommet mounted to the cabinet and positioned over the tub; and
a wiring harness electrically connecting the control board and the electric component, a first portion of the wiring harness fixed to the tub at a top portion of the tub, a second portion of the wiring harness received within the grommet such that the wiring harness is slidable within the grommet.

11. The vertical axis washing machine appliance of claim 10, wherein the wiring harness slidable along a vertical direction within the grommet, and the grommet constrains motion of the wiring harness within the grommet in a plane that is perpendicular to the vertical direction.

12. The vertical axis washing machine appliance of claim 10, wherein a length of the wiring harness between the first and second portions of the wiring harness varies when the wiring harness slides within the grommet.

13. The vertical axis washing machine appliance of claim 10, wherein the grommet defines a through hole, and the second portion of the wiring harness is received within the through hole of the grommet.

14. The vertical axis washing machine appliance of claim 13, wherein a diameter of the through hole is greater than a diameter of the wiring harness received within the through hole of the grommet.

15. The vertical axis washing machine appliance of claim 10, wherein the electrical component comprises a motor coupled to the basket, and the motor is operable to rotate the basket within the tub.

16. The vertical axis washing machine appliance of claim 10, wherein the wiring harness has a sheath material with a first hardness, the grommet has a material with a second hardness, the sheath material with the first hardness contacts the material of the grommet with the second hardness, and the first hardness is greater than the second hardness.

17. The vertical axis washing machine appliance of claim 10, wherein the wiring harness comprises a plurality of conductive wires.

18. The vertical axis washing machine appliance of claim 10, wherein an additional grommet is overmolded to the wiring harness at the first portion of the wiring harness, and the additional grommet is fixed to the tub.

19. A washing machine appliance, comprising:
a cabinet;
a tub suspended within the cabinet such that the tub is movable relative to the cabinet;
a basket rotatably mounted within the tub;
a control board positioned within the cabinet such that the control board is spaced from the tub;
an electric component mounted to the tub;
a grommet; and
a wiring harness electrically connecting the control board and the electric component,
wherein the grommet is mounted to one of the cabinet and the tub, a first portion of the wiring harness is fixed to the other of the cabinet and the tub, and a second portion of the wiring harness received within the grommet such that the wiring harness is slidable within the grommet.
